(19) United States
(12) Patent Application Publication
(10) Pub. No.: US 2010/0013850 A1
(43) Pub. Date: Jan. 21, 2010

(54) LIQUID CRYSTAL DISPLAY DEVICE

(76) Inventor: Myoung-Ho Kwon, Suwon-si (KR)

Correspondence Address: CHRISTIE, PARKER & HALE, LLP, PO BOX 7068, PASADENA, CA, 91109-7068, US

(21) Appl. No.: 12/503,634

(22) Filed: Jul. 15, 2009

(30) Foreign Application Priority Data
Jul. 16, 2008 (KR) 10-2008-0069020

(51) Int. Cl. G09G 3/36; G09G 5/02

(52) U.S. Cl. 345/589; 345/102; 349/116

(57) ABSTRACT

A liquid crystal display device including a display unit and a backlight for illuminating the display unit. An optical sensor outputs a light sensing signal corresponding to brightness of external light, and an infrared cut-off filter is in a path along which the external light is incident to the optical sensor. The backlight is configured to control a luminance of light illuminating the display unit in accordance with the light sensing signal.

### CROSS-REFERENCE TO RELATED APPLICATIONS

This application claims priority to and the benefit of Korean Patent Application No. 10-2008-0069020, filed on Jul. 16, 2008, in the Korean Intellectual Property Office, the entire content of which is incorporated herein by reference.

### BACKGROUND OF THE INVENTION

1. Field of the Invention

The present invention relates to a liquid crystal display device and more particularly to a liquid crystal display device including an optical sensor.

2. Description of Related Art

Recently, various flat panel display devices having a reduced weight and volume compared to cathode ray tubes have been developed. Flat panel display devices include liquid crystal displays (LCDs), field emission displays (FEDs), plasma display panels (PDPs), light emitting displays (LEDs), etc.

Among other flat panel display devices, liquid crystal display devices have advantages such as small size, light weight, low power consumption, etc., so that they have gradually been spotlighted as an alternative to overcome disadvantages of existing cathode ray tubes. Accordingly, liquid crystal display devices have been widely applied to portable devices such as cellular phones, portable digital assistants (PDAs), etc., as well as monitors, TVs, etc., which are typically middle or large-sized products.

A liquid crystal display device includes a liquid crystal display panel having a liquid crystal layer interposed between two substrates, and frequently, a backlight supplying light to the liquid crystal display panel.

In the liquid crystal display device in the related art, the backlight irradiates light with a substantially constant, uniform brightness to the liquid crystal display panel. However, even when a great amount of light is not required, such as a place with relatively high display visibility due to a dark ambient environment, light with a constant, uniform brightness is supplied to the liquid crystal display panel and the power consumption of the backlight is relatively high. In fact, more than 80% of the power consumed to drive a liquid crystal display device is consumed by the backlight.

### SUMMARY OF THE INVENTION

Embodiments of the present invention are directed to a liquid crystal display device that controls the amount of light from its backlight corresponding to the brightness of external, or ambient light perceived by a viewer. The liquid crystal display device includes an optical sensor capable of outputting a light sensing signal according to the person's perception of visible light.

A liquid crystal display device according to an exemplary embodiment of the present invention includes a display panel and a backlight for illuminating the display panel. An optical sensor outputs a light sensing signal corresponding to brightness of external light, and an infrared cut-off filter is in a path along which the external light is incident on the optical sensor. The backlight is configured to control a luminance of light illuminating the display panel in correspondence to the light sensing signal.

The optical sensor may be formed at a periphery of the display panel, and the infrared cut-off filter may include an infrared blocking material on a front polarizing plate of the display panel.

Also, the infrared cut-off filter may include the infrared blocking material on a window on the display panel.

According to various embodiments of the present invention, the infrared cut-off filter is in a light receiver of the optical sensor which senses the brightness of external light. Thereby, the infrared components of the external light have a minimal effect on the operation of the optical sensor, and the optical sensor can output the light sensing signal in closer correspondence to visible components visually perceived by the viewer. Therefore, the liquid crystal display device according to some embodiments of the present invention prevents a malfunction of the optical sensor due to the infrared components, and perceives the brightness of the external light similar to a viewer's perception, making it possible to ensure the reliability of the optical sensor and efficiently control the light amount from the backlight.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram schematically showing one example of a liquid crystal display device including an optical sensor;

FIG. 2 is a plan view showing one example of a liquid crystal display device according to one embodiment of the present invention;

FIG. 3 is a plan view showing one example of a liquid crystal display device according to another embodiment of the present invention; and

FIG. 4 is a graph showing a response curve of an optical sensor by optical wavelength bands.

### DETAILED DESCRIPTION OF EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Hereinafter, like reference numerals refer to like elements.

Hereinafter, certain exemplary embodiments according to the present invention will be described with reference to the accompanying drawings.

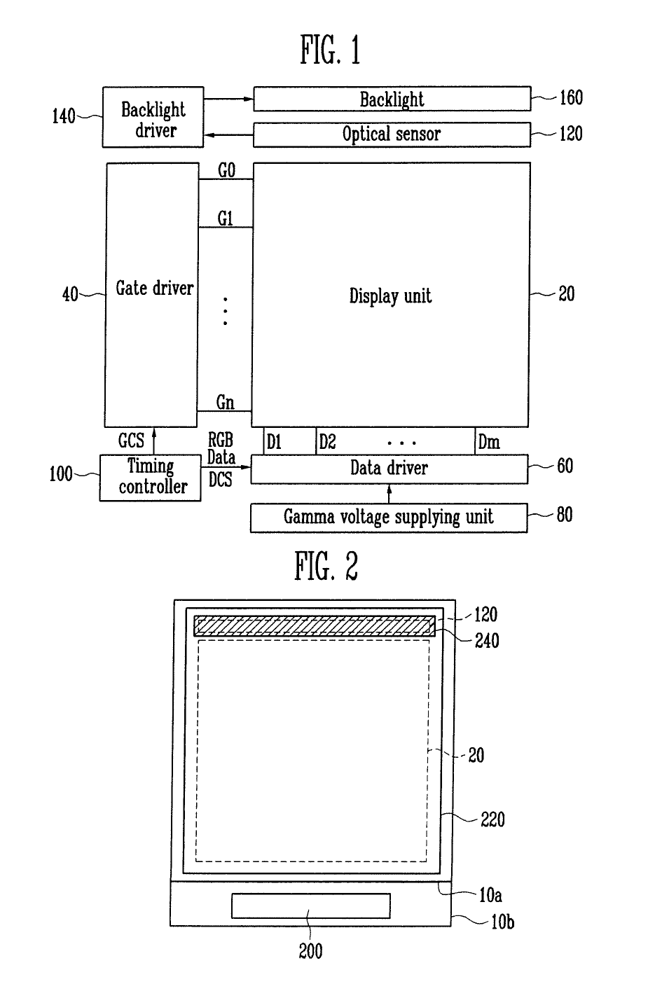

FIG. 1 is a block diagram schematically showing one example of a liquid crystal display device including an optical sensor.

Referring to FIG. 1, a liquid crystal display device includes a display unit (e.g., a display panel) 20, a gate driver 40, a data driver 60, a gamma voltage supplying unit 80, a timing controller 100, an optical sensor 120, a backlight driver 140 and a backlight 160.

The display unit 20 includes a plurality of a liquid crystal cells (not shown) which are formed where gate lines G0 to Gn cross data lines D1 to Dm. Arrangement angles of the liquid crystals are changed in the liquid crystal cells corresponding to the data signal when a gate signal is applied to a gate line G. Thereby, the transmittance of light which is supplied from the backlight 160 to the display unit 20 is changed, such that each liquid crystal cell emits light with luminance corresponding to the data signal.

The gate driver 40 sequentially supplies the gate signals to the gate lines G0 to Gn corresponding to a gate control signal GCS which is supplied from a timing controller 100. Therefore, horizontal lines of the display unit 20 supplied with the data signal are sequentially selected.

The data driver 60 converts digital video data RGB Data into analog gamma voltages corresponding to gray level values, i.e., the data signal, in accordance with the data control signal DCS supplied from the timing controller 100. Then, the data driver 60 supplies the converted data signal to the data lines D1 to Dm.

The gamma voltage supplying unit 80 supplies a plurality of gamma voltages to the data driver 60.

The timing controller 100 generates a data control signal DCS and a gate control signal GCS to control data driver 60 and the gate driver 40, respectively, using a clock signal CLK and vertical/horizontal synchronizing signals Vsync and Hsync supplied from the outside. At this time, the gate control signal GCS for controlling the gate driver 40 includes a gate start pulse, a gate shift clock, a gate output enable signal, etc. Also, the data control signal CS for controlling the data driver 60 includes a source start pulse, a source shift clock, a source output enable signal, a polarity signal, etc. Also, the timing controller 100 supplies the video data RGB Data supplied from the outside to the data driver 60.

The optical sensor 120 is positioned at a side of a liquid crystal display device to be generally at the periphery of the display unit 20, and includes one or more light sensing devices for receiving external light. Thereby, the optical sensor 120 senses the brightness of external light in the environment to which the display unit 20 is exposed. The optical sensor 120 generates the light sensing signal corresponding to the brightness of the external light and supplies the generated light sensing signal to the backlight driver 140, thereby controlling the backlight driver 140.

The backlight driver 140 supplies the driving voltage (or driving current) for driving the backlight 160 to the backlight 160. At this time, the backlight driver 140 changes the value of the driving voltage (or driving current) corresponding to the light sensing signal supplied from the optical sensor 120, thereby controlling the luminance of the light from the backlight 160.

The backlight 160 generates light corresponding to the driving voltage (or driving current) supplied from the backlight driver 140 and supplies the generated light to the display unit 20.

The aforementioned liquid crystal display device includes the optical sensor 120 to sense the brightness of external light and controls the luminance of light generated from the backlight corresponding to the sensed brightness. Thereby, power consumption can be reduced.

According to various embodiments, the light sensing device in the optical sensor 120 may be a photo diode, a thin film transistor (hereinafter, referred to as TFT), or any other suitable light sensing device. In an exemplary embodiment, a light sensing device is a reverse biased (diode connected) TFT formed concurrently with the TFTs of the display unit 20.

However, due to characteristics of silicon of the TFT in the optical sensor 120, the light sensing device shows different sensitivity according to the wavelength of light. In particular, the light sensing devices have increasing sensitivity to light toward the infrared region of the spectrum.

However, because a person's eye only perceives light in a visible region of the spectrum, which is different from the infrared region, the optical sensor 120 for light does not match the sensitivity of the viewer. Thereby, it may be difficult to effectively control the amount of light from backlight 160 corresponding to the brightness of the external light perceived by the viewer. Also, because the optical sensor 120 has a relatively high sensitivity to the infrared components of the external light, the optical sensor 120 can malfunction due to the infrared light.

Accordingly, in an exemplary embodiment of the present invention, an infrared cut-off filter is placed or formed in a light receiver of the optical sensor 120, so that the optical sensor 120 outputs the light sensing signal in closer correspondence to the viewer's sensitivity to light.

FIG. 2 is a plan view showing a liquid crystal display device according to an exemplary embodiment of the present invention. For convenience, one surface of the liquid crystal display panel (a surface displaying an image) is showed in FIG. 2.

Referring to FIG. 2, the liquid crystal display panel includes the display unit 20 and the optical sensor 120 formed between an upper substrate 10a and a lower substrate 10b, and a driving integrated circuit IC 200 mounted on one side of the lower substrate 10b. Herein, the driving IC 200 can include the gate driver 40 and/or the data driver 60, etc., shown in FIG. 1. A front polarizing plate 220 is placed on an upper side of the upper substrate 10a.

In the present embodiment, an infrared blocking material is coated on one region of the front polarizing plate 220 corresponding to the location of the optical sensor 120 to form an infrared cut-off filter 240. In some embodiments, the infrared cut-off filter is formed of silicon dioxide (SiO2) or titanium dioxide (TiO2), although other suitable materials may be utilized for blocking infrared rays. The infrared cut-off filter 240 may be formed at the front or the rear of the front polarizing plate 220. Thus, the infrared cut-off filter 240 is arranged in the path of the external light directed toward the optical sensor 120, interrupting the infrared components of the external light from being incident on the optical sensor 120.

Accordingly, the optical sensor 120 receives external light where the infrared components are substantially removed, thereby reducing or minimizing the infrared components of the external light that may have an effect on the operation of the optical sensor 120, and allowing the optical sensor 120 to output the light sensing signal in closer correspondence to the visible components visually perceived by the viewer.

Therefore, various embodiments of the present invention reduce or prevent the malfunction of the optical sensor 120 due to the infrared components, and sense the brightness of light more closely corresponding to a viewer's perception, improving the operation reliability of the optical sensor 120 and efficiently controlling the amount of light from the backlight (160 of FIG. 1).

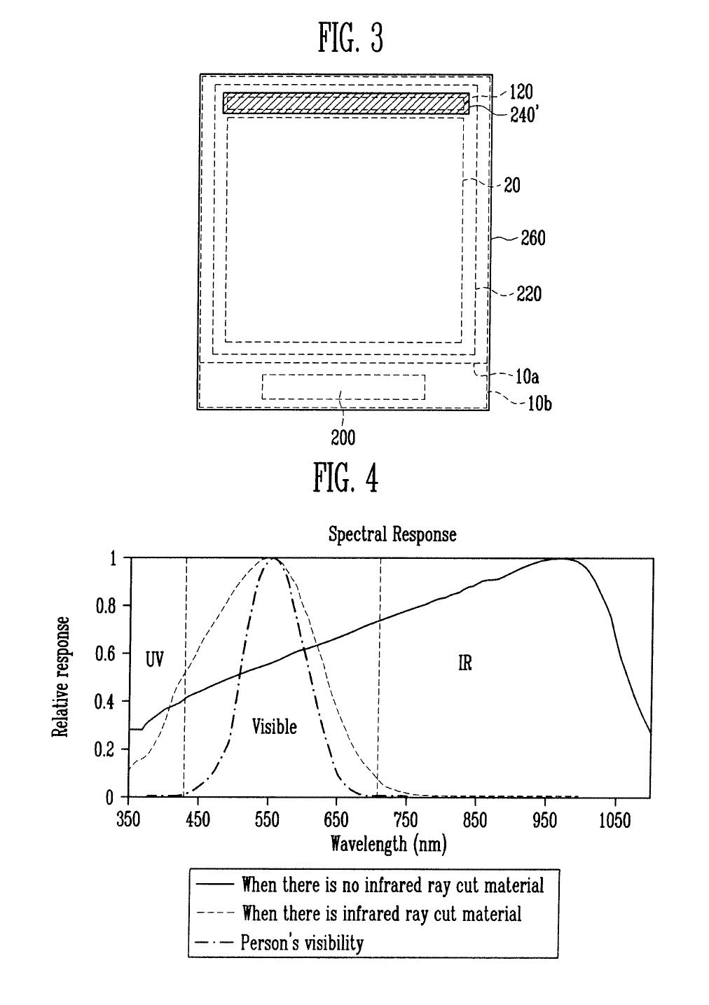

FIG. 3 is a plan view showing a liquid crystal display device according to another exemplary embodiment of the present invention, showing the liquid crystal display panel having the window mounted on the upper side thereof. For convenience, FIG. 3 uses the same reference numerals for the same portions with FIG. 2 and the detailed description thereof will be omitted.

Referring to FIG. 3, an infrared cut-off filter 240′ according to the present embodiment is formed on one surface of a window 260. More specifically, the infrared cut-off filter 240′ according to the present embodiment is formed of infrared blocking material coated on one region of the window 260 so as to be positioned on the optical path along which the external light is incident on the optical sensor 120. Thereby, the infrared components of the external light incident on the optical sensor 120 are substantially removed.

With the above mentioned embodiments illustrated in FIG. 2 and FIG. 3, the infrared cut-off filter 240 or 240′ is formed on the front polarizing plate 220 or on the window 260, respectively, but the present invention is not limited thereto. For example, in the case of a liquid crystal display device designed in a form not covering the front polarizing plate 220, the infrared blocking material can be coated on the optical sensor 120 (for instance, the upper layer of the light receiver), making it possible to form the infrared cut-off filter. Also, in a liquid crystal display device designed in a form of a touch screen panel, when the touch screen panel is arranged at the upper side of the optical sensor 120, the infrared cut-off filter can be coated on the touch screen panel to correspond to the optical sensor 120.

In other words, the position of the infrared cut-off filter according to various embodiments of the present invention is not limited, and is generally arranged on the optical path along which the external light is incident to the optical sensor 120.

FIG. 4 is a graph showing an effect of one embodiment of the present invention, wherein a response curve of an optical sensor is illustrated by optical wavelength bands. FIG. 4 shows a normalized response of the optical sensor to light of varying wavelengths.

Referring to FIG. 4, when the infrared cut-off filter is not formed in the incident path of the external light (that is, light receiver), the optical sensor shows relatively high sensitivity to the infrared components of the light. The response of the optical sensor without an infrared cut-off filter is seen to be substantially different form from the viewer's sensitivity to light.

However, when the infrared cut-off filter is formed in the incident path of the external light, the response of the optical sensor is seen to be substantially similar to the viewer's sensitivity to light.

In other words, by arranging the infrared cut-off filter in the incident path of the external light, the infrared components of the external light that would otherwise affect the operation of the optical sensor can be reduced or minimized and the optical sensor can output the light sensing signal in a similar form to person's visual sensitivity.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A liquid crystal display device comprising:
a display unit;
a backlight for illuminating the display unit;
an optical sensor for outputting a light sensing signal corresponding to brightness of external light; and
an infrared cut-off filter in a path along which the external light is incident on the optical sensor,
wherein the backlight is configured to control a luminance of light illuminating the display unit in accordance with the light sensing signal.

2. The liquid crystal display device as claimed in claim 1, wherein the optical sensor is at a periphery of the display unit, and the infrared cut-off filter comprises an infrared blocking material on a front polarizing plate on the display unit.

3. The liquid crystal display device as claimed in claim 2, wherein the infrared cut-off filter is in a region of the front polarizing plate corresponding to the optical sensor.

4. The liquid crystal display device as claimed in claim 1, wherein the optical sensor is at a periphery of the display unit, and the infrared cut-off filter comprises an infrared blocking material on a window on the display unit.

5. The liquid crystal display device as claimed in claim 4, wherein the infrared cut-off filter is in a region of the window corresponding to the optical sensor.

6. The liquid crystal display device as claimed in claim 1, wherein the optical sensor comprises a thin film transistor.

7. The liquid crystal display device as claimed in claim 6, wherein the thin film transistor comprises a gate, a source, and a drain, and wherein the thin film transistor is diode-connected such that the gate is coupled to the source or the drain.

8. The liquid crystal display device as claimed in claim 6, wherein the display unit comprises a plurality of thin film transistors, and wherein the thin film transistor of the optical sensor is manufactured concurrently with the plurality of thin film transistors of the display unit.

9. The liquid crystal display device as claimed in claim 1, wherein a sensitivity of the optical sensor to light substantially corresponds to a sensitivity of a human eye to light.

10. A method of driving a backlight in a liquid crystal display device, the method comprising:
blocking infrared components of ambient light from reaching an optical sensor;
sensing a brightness of the ambient light from other than the backlight;
generating a light sensing signal that corresponds to the brightness of the ambient light;
controlling a backlight brightness of the backlight in correspondence to the light sensing signal.

11. The method of claim 6, wherein blocking the infrared components of the ambient light comprises substantially transmitting visible components of the ambient light.
